(19) United States
(12) Patent Application Publication
(10) Pub. No.: US 2016/0318770 A1
(43) Pub. Date: Nov. 3, 2016

(54) A STORAGE AND DISPENSING APPARATUS

(71) Applicant: DOWNER EDI MINING - BLASTING SERVICES PTY LTD, South Brisbane, Queensland (AU)

(72) Inventor: Ernesto Guillermo MOLLICA, Heathwood, Queensland (AU)

(21) Appl. No.: 15/106,601

(22) PCT Filed: Dec. 20, 2013
(86) PCT No.: PCT/AU2013/001511

§ 371 Date: Jun. 20, 2016

(51) Int. Cl. C01C 1/18; C06B 31/28; B65D 88/28; B65D 88/32; E21C 37/00; B65D 88/54

(52) U.S. Cl. CPC C01C 1/18; E21C 37/00; B65D 88/54; B65D 88/28; B65D 88/32; C06B 31/28

(57) ABSTRACT

A storage and dispensing apparatus able to store and dispensing ammonium nitrate, the apparatus comprising at least one rotatable bowl able to store ammonium nitrate a drive unit connected to the rotatable bowl to rotate the bowl at least one delivery unit to deliver ammonium nitrate to the at least one rotatable bowl; and at least one dispensing unit to delivery ammonium nitrate from the at least one rotatable bowl.

### FIELD OF THE INVENTION

The invention relates to a storage and dispensing apparatus. In particular, the invention relates to the storage and dispensing of ammonium nitrate on mine sites and therefore will be described in this context. However, it should be appreciated that the invention may be used for other purposes.

### BACKGROUND TO THE INVENTION

Reference to background art herein is not to be construed as an admission that such art constitutes common general knowledge in Australia or elsewhere.

Ammonium nitrate is a blasting agent that is used extensively in the mining industry throughout the world. Ammonium nitrate is typically mixed with fuel oil to create a range of explosive products know as ANFO, HANFO and gassed matrixes. The explosive is relatively stable, easy to produce and relatively inexpensive. Large quantities of explosive product delivered into blast holes by mobile processing units (MPUs) which carry raw materials such as ammonium nitrate emulsion, fuel oil and ammonium nitrate which are mixed just prior to delivery in blast holes. Accordingly, large quantities of the blasting agents must be kept on site ready to refill the MPUs.

Historically the bulk storage and delivery of ammonium nitrate at mine sites has been through the use of storage bins and silos. There has been a range of issues associated with this type of storage and delivery of ammonium nitrate from both a physical and commercial perspective. Any storage and delivery facility must be capable of storing a large quantity of ammonium nitrate securely and safely. Further, it is advantageous to have a storage and delivery facility that does not require extensive in ground footings that are generally required by silo or bins. That is, it is desirable to provide a facility that is re-locatable to another site. Other considerations for the storage and delivery of ammonium nitrate from a facility include:
The ability to receive and deliver ammonium nitrate at rates at least consistent with current industry facilities;
Being unaffected by “Blocky” or heavily dusted ammonium nitrate;
Being fundamental stable regardless of the capacity;
Being unaffected by the caking of the ammonium nitrate (i.e. the ammonium nitrate being resistant to flow);
Being able to deliver known quantities of ammonium nitrate;
Being safe to operate;
Protecting the ammonium nitrate from the weather; and
Being able to keep ammonium nitrate secure.

### OBJECT OF THE INVENTION

It is an object the invention to provide a storage and dispensing apparatus which overcomes or ameliorates one or more of the above disadvantages and/or provides the consumer with a useful or commercial choice.

Other preferred objects of the present invention will become apparent from the following description.

### SUMMARY OF INVENTION

In one form, although not necessarily the only or broadest form, the invention resides in a storage and dispensing apparatus able to store and dispense ammonium nitrate, the apparatus comprising:

at least one rotatable bowl able to store ammonium nitrate;

a drive unit connected to the rotatable bowl to rotate the bowl;

at least one delivery unit to deliver ammonium nitrate to the at least one rotatable bowl; and

at least one dispensing unit to delivery ammonium nitrate from the at least one rotatable bowl.

Typically there are two rotatable bowls. However, it is envisaged that there may be three or more rotatable bowls.

Each bowl is typically elongate and is formed from a substantially cylindrical section with two truncated cones located at each end.

Each bowl is normally inclined at an inclination angle. The inclination angle is typically between 1 degrees and 45 degrees. More preferably, the inclination angle is between 5 degrees and 30 degrees.

Each bowl typically includes one or more internal flights. Normally there is only a single flight. The flight is typically in the form of a screw. More preferably the screw is in the form of an Archimedes screw.

The bowls are typically, mounted on a frame. The frame is typically located on a ground surface. However, it would be appreciated that the frame may form part of a vehicle or may be located on wheels or rollers or tracks.

The drive unit typically includes at least one bowl drive motor. Normally each bowl has an individual bowl motor. The bowl motor may be connected directly to the bowl or alternatively may indirectly connected to the bowl through other components such as one or more chains or gears. An external source of power is normally used to drive the bowl drive motor. The external power source is typically a pump and/or motor.

At least one scale may be used to determine the weight of the at least one bowl. Normally, there is a scale for each of the bowls. The scale is typically in the form of a load cell.

Normally there is only a single delivery unit. The delivery unit typically includes a first delivery .hopper to capture delivered ammonium nitrate and a first delivery conveyor to deliver ammonium nitrate from the delivery hopper to the at one least one rotatable bowl. First delivery hopper and the first delivery conveyor may be fixed in position The first delivery conveyor is typically a belt conveyor or an auger.

The delivery unit may also include a second delivery hopper to capture ammonium nitrate and a second delivery conveyor to delivery ammonium nitrate to the to the first delivery hopper. The second delivery hopper and second delivery conveyor may be movable with respect to the first delivery hopper. Normally, the second delivery hopper and second delivery conveyor are rotatable with respect to the first delivery hopper. The second delivery conveyor is typically a belt conveyor or an auger.

The delivery conveyor may be able to deliver ammonium nitrate directly to the at least one bowl. However, a distributor is typically used when there is two or more rotatable bowls. That is, distributor may direct ammonium nitrite to one of the bowls.

The delivery conveyor is typically rotatable with respect to the distributor and/or the at least one rotatable bowl. Normally the delivery unit is mounted on a carriage to assist with rotational movement of the delivery conveyor.

Normally there is a single dispensing unit. The dispensing unit may include a dispensing hopper for collecting ammonium nitrate from the at least one rotatable bowl and a dispensing conveyor to dispense ammonium nitrate from the dispensing hopper. The dispensing conveyor is typically a belt conveyor or an auger conveyor.

The dispensing unit is normally able to move up and down with respect to the bowl. A lifting device may be used for this purpose.

In another form, the invention resides in a method of storing and dispensing a ammonium nitrate including the steps of:
storing ammonium nitrate in a rotatable bowl by rotating the rotatable bowl in one direction; and
dispensing ammonium nitrate from the rotatable bowl by rotating the rotatable bowl.

The method may include one or more of the following steps singularly or in combination:
delivering ammonium nitrate from a vehicle to the rotatable bowl; and/or
delivering ammonium nitrate to the rotatable bowl via a delivery unit; and/or
delivering ammonium to the rotatable bowl via a delivery conveyor; and/or
dispensing ammonium nitrate from the rotatable bowl to a vehicle; and/or
dispensing ammonium nitrate to the rotatable bowl via a dispensing unit; and/or
delivering ammonium to the rotatable bowl via a dispensing conveyor.

Further features and advantages of the present invention will become apparent from the following detailed description.

### BRIEF DESCRIPTION OF THE DRAWINGS

An embodiment of the invention, by way of example only, will be described with reference of the accompany drawings in which:

FIG. 1 is a front perspective view of a storage and dispensing apparatus according to an embodiment of the invention;

FIG. 2 is a rear perspective view of the storage and dispensing apparatus according to an embodiment of the invention; and

FIG. 3 is a front view of the storage and dispensing apparatus according to an embodiment of the invention:

### DETAILED DESCRIPTION OF THE DRAWINGS

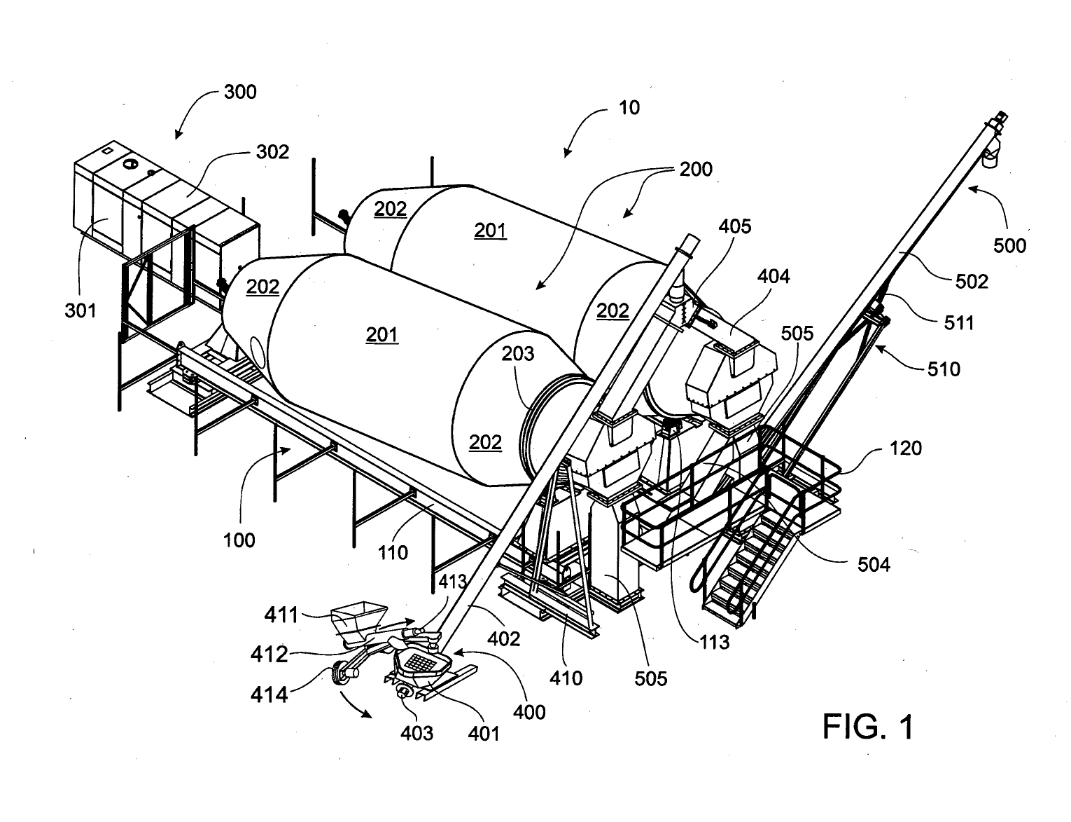

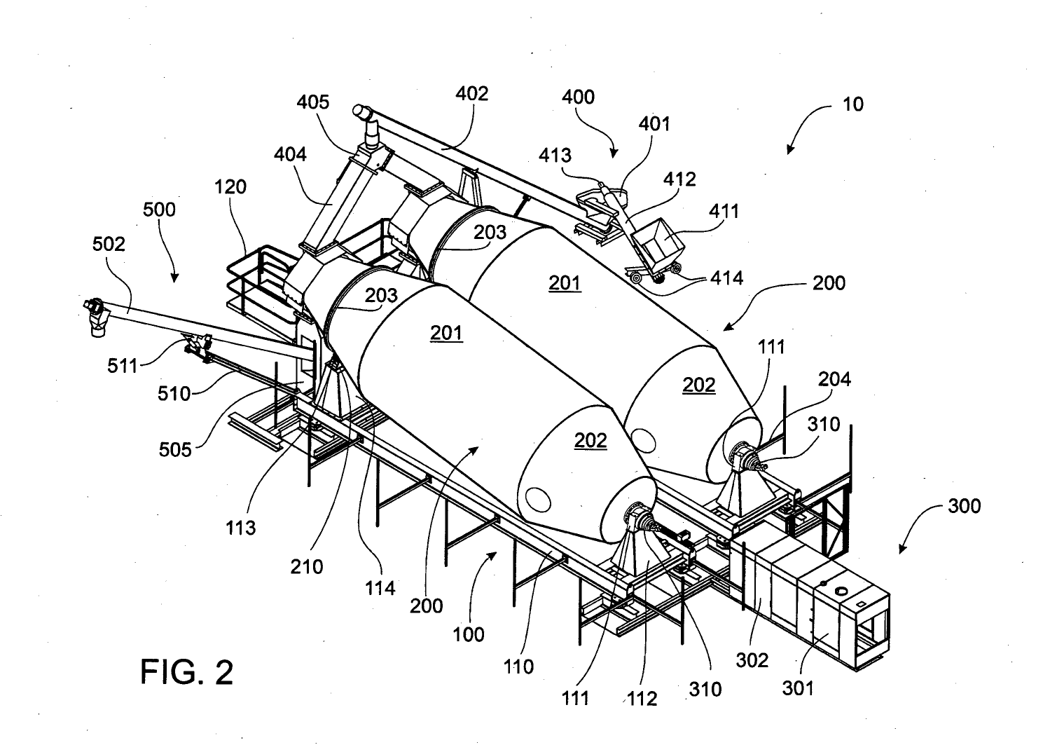

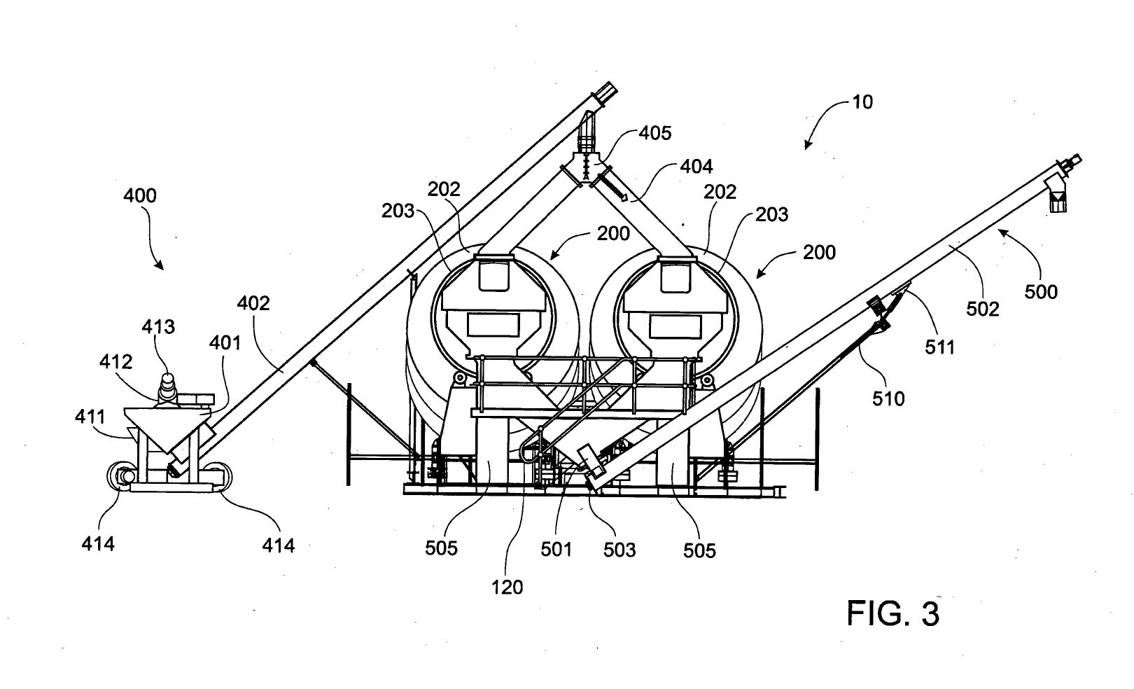

FIGS. 1 to 3 illustrates a storage and dispensing apparatus 10 according to an embodiment of the invention. The storage and dispensing apparatus 10 includes a frame 100, two rotatable bowls 200, a drive unit 300, a delivery unit 400, and a dispensing unit 500.

The frame 100 is primarily used to support the two rotatable bowls 200, the drive unit 300, delivery unit 400 and the dispensing unit 500. The frame 100 includes a base 110 which is located below the two rotatable bowls 200 and access platform 120 located at a front of the bowls 200.

The two rotatable bawls 200 are used for both storing and dispensing ammonium nitrate. Accordingly, each of the rotatable bowls 200 is hollow. Each bowl 200 typically includes an internal flight (not shown) in form of an Archimedes screw. Each rotatable bowl 200 is formed from a substantially cylindrical section 201 with two truncated cones 202 located at each end. A circumferential mounting track 203 extends around each of the front truncated cones. An axially extending shaft 204 is connected to each of the rear truncated cones.

Each of the rotatable bowls 200 is mounted for rotation on the base 110 of the frame 100. Each shaft 204 is rotatably mounted to a respective shaft bearing 111 which is supported by a rear bowl mount 112 that extends upwardly from the base 110 of the frame 100. Each circumferential mounting track 203 is rotatably supported by two trunnion rollers 113 that engage with the mounting track 203. The two trunnion rollers 113 are located on a front bowl mount 114. The height of the front bowl mount 114 with respect to the rear bowl 112 mount is such that each rotatable bowl is inclined at an approximate inclination angle of 15 degrees. It would be appreciated by a person skilled in the art that the inclination angle may be varied.

Two load cells 210 are located underneath the respective rotatable bowls 200 to determine the weight of the rotatable bowls 200 and hence the amount of ammonium nitrate located within the rotatable bowls 200. The two load cell are located between the front bowl mounts 114 the rotatable bowls 200. However it should be appreciated that the two load cell may be located between the rear bowl mounts 112 and the rotatable bowls 200.

The drive unit 300 is, located at the rear of the rotatable bowls 200. The drive unit 300 provides power to operate the storage and dispensing apparatus including operating the rotatable bowls 200, operating the delivery unit 400 and operating the dispensing unit 500. The drive unit 300 includes a diesel engine 301 which operates a main hydraulic pump 302.

Two hydraulic bowl drive motors 310 are mounted adjacent their respective rear truncated cones 202 to rotate their respective rotatable bowls 200. The hydraulic pump 302 supplies hydraulic fluid to drive the hydraulic bowl drive motors 310. It would be appreciated by a person skilled in the art that a bowl drive motors 310 may be directly connected to the rotatable bowl 202 as shown or could be indirectly connected to the rotatable bowls 202 via an indirect manner through the use of a chain or gears as is known in the art.

The delivery unit 400 is used to deliver ammonium nitrate from a delivery vehicle (not shown) to the rotatable bowls 202. The delivery unit 400 includes a first delivery hopper 401 located at one end of a first delivery auger 402. The delivery auger 402 extends from adjacent position below the rotatable bowls 200 to a position above the rotatable bowls 200 at an inclined angle. The first delivery auger 402 is powered by a first delivery auger motor 403 that is located adjacent one end of the first delivery auger 402.

A split delivery chute 404 is located adjacent a top end of the delivery auger 402 and divergently extends to an opening in each of the rotatable bowls 202. A distributor 405 is located within a top of the delivery chute 404 to distribute ammonium nitrate down a selected side of the delivery chute 404 to a selected rotatable bowl 200. The distributor 405 is in the form of a pivotal flap in this embodiment. However, it would be appreciated by a person skilled in the art that the distributor may be of other forms.

The delivery auger 402 is pivotally attached to the delivery chute adjacent the distributor 405. The delivery hopper 401 and the delivery auger 402 are supported by a deliver unit frame which is attached to the delivery auger 402.

The delivery unit 400 also includes a second delivery hopper 411 located at one end of a second delivery auger 412. The second delivery auger 412 extends from adjacent position below the first delivery hopper 401 to a position above the first delivery hopper 401 at an inclined angle. The second delivery auger 412 is powered by a second delivery auger motor 413 that is located adjacent one end of the second delivery auger 412.

The top of the second delivery auger 412 is pivotally mounted to the adjacent the first delivery hopper 401. The second delivery hopper 411 is mounted on wheels 414 that allow the second delivery hopper 411 and the second delivery auger 412 to swing with respect to the first delivery hopper 401 and first delivery auger 402.

The dispensing unit 500 is used to dispense ammonium nitrate to MPUs (not shown). The dispensing unit 500 includes a dispensing hopper 501 located at one end of a dispensing auger 502. The dispensing auger 502 extends from adjacent position below the rotatable bowls 200 to a position above the dispensing bowls 502 at an inclined angle. The dispensing auger 502 is powered by a dispensing auger motor 503 that is located adjacent one end of the dispensing auger 502. The delivery auger motor 503 is a hydraulic motor and is drive by main hydraulic pump 302.

A split dispensing chute 504 is located adjacent the openings of each of the rotatable bowls 200 and convergently extends towards the ground. The dispensing hopper 501 is located below an opening in the dispensing chute 504. Chute supports 505 support the dispensing chute 504.

The dispensing auger 502 is pivotally supported by a dispensing unit frame 510. That is the dispensing unit frame 510 forms a lifting device to enable the dispensing ager 502 to be lifted up and down as desired. A lifting hydraulic ram 511 forms part of the dispensing unit frame 510 that provides the lifting force. The dispensing auger 502 extends through one of the chute supports.

In use, a delivery vehicle that contains ammonium nitrate is driven adjacent the storage and delivery apparatus 10 on the side that has the delivery unit 400. The second delivery hoper 41.1 is then located adjacent the delivery vehicle. The rotatable bowl 200 in which the ammonium nitrate is to be placed is selected and accordingly rotated in a clockwise direction. Similarly, the distributor 405 is activated to ensure any ammonium nitrate is feed into the side of delivery chute 404 that is connected to the rotating rotatable bowl 200. The ammonium nitrate is then delivered into the second delivery hopper 411. The second delivery auger 412 is operated to transport ammonium nitrate from the second delivery hopper 411 to the first delivery hopper 401. The first delivery auger 401 then delivers ammonium nitrate to the chute 404. The ammonium nitrate then falls through the delivery chute 404 and into the rotating rotatable bowl 200. The flight located with the rotatable bowl draws the ammonium nitrate into the rotatable bowl 200.

When ammonium nitrate is required for blasting, a MPU is driven adjacent the storage and delivery apparatus 10 on the side that has the dispensing unit 500. The height of the dispensing auger 502 using the dispensing unit fame 510 is lowered so that the end of the dispensing auger 502 is located adjacent a filling opening of the MPU. One of the rotatable bowls 200 that contains ammonium nitrate is selected and then rotated in an anti-clockwise direction. This causes the flights to located within the rotatable bowl 200 to feed ammonium nitrate from the inside the rotatable bowl into the dispensing chute 504. The ammonium nitrate then falls through the dispensing chute 504 and into the dispensing hopper 501. The dispensing auger 502 then transports the ammonium nitrate from the delivery hopper 501 into the MPU.

The storage and dispensing apparatus 10 above provides the necessary functionality as stated in the background namely:
The ability to receive and deliver ammonium nitrate at rates at least consistent with current industry facilities;
Being unaffected by “Blocky” or heavily dusted ammonium nitrate;
Being fundamental stable regardless of the capacity;
Being unaffected by the caking of the ammonium nitrate (i.e. the ammonium nitrate being resistant to flow);
Being able to deliver known quantities of ammonium nitrate;
Being safe to operate and
Protecting the ammonium nitrate from the weather.
Being able to keep ammonium nitrate secure.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. An ammonium nitrate storage and dispensing apparatus comprising:
at least two rotatable bowls able to store ammonium nitrate;
a drive unit connected to each of the rotatable bowls to rotate the bowls;
at least one delivery unit to deliver ammonium nitrate to the at least two rotatable bowls; and
at least one dispensing unit to deliver ammonium nitrate from the at least two rotatable bowls.

2. The ammonium nitrate storage and dispensing apparatus of claim 1 wherein each bowl is formed from a substantially cylindrical section with two truncated cones located at each end.

3. The ammonium nitrate storage and dispensing apparatus of claim 1 wherein each bowl is normally inclined at an inclination angle.

4. The ammonium nitrate storage and dispensing apparatus of claim 3 wherein the inclination angle is between 1 degrees and 45 degrees.

5. The ammonium nitrate storage and dispensing apparatus of claim of claim 3 wherein the inclination angle is between 5 degrees and 30 degrees.

6. The ammonium nitrate storage and dispensing apparatus of claim 1 wherein each bowl includes one or more internal flights.

7. The ammonium nitrate storage and dispensing apparatus of claim 6 wherein there is only a single flight.

8. The ammonium nitrate storage and dispensing apparatus of claim 6 or claim 7 wherein each flight is in the form of a screw.

9. The ammonium nitrate storage and dispensing apparatus of claim 1 wherein the at least two bowls are mounted on a frame.

10. The ammonium nitrate storage and dispensing apparatus of claim 1 wherein the drive unit includes at least one bowl drive motor.

11. The ammonium nitrate storage and dispensing apparatus of claim 1 wherein each bowl has an individual bowl motor.

12. The ammonium nitrate storage and dispensing apparatus of any claim 1 wherein at least one scale is associated with the at least two rotatable bowls to determine the weight of the at least two rotatable bowls.

13. The ammonium nitrate storage and dispensing apparatus of claim 12 wherein there is a scale for each of the bowls.

14. The ammonium nitrate storage and dispensing apparatus of claim 12 wherein the scale is in the form of a load cell.

15. The ammonium nitrate storage and dispensing apparatus of claim 1 wherein there is a single delivery unit.

16. The ammonium nitrate storage and dispensing apparatus of claim 1 wherein the deliver unit includes at least one delivery hopper to capture delivered ammonium nitrate and at least one delivery conveyor to deliver ammonium nitrate from the delivery hopper to at least one of the at least two rotatable bowls.

17. The ammonium nitrate storage and dispensing apparatus of claim 16 wherein the delivery unit further comprises a second delivery hopper to capture ammonium nitrate and a second delivery conveyor to deliver ammonium nitrate to the at least one delivery hopper.

18. The ammonium nitrate storage and dispensing apparatus of claim 17 wherein the second delivery hopper and the second delivery conveyor are movable with respect to the at least one delivery hopper.

19. The ammonium nitrate storage and dispensing apparatus of claim 1 wherein the at least two rotatable bowls, the at least one delivery unit and the at least one dispensing unit define at least two enclosed chambers.

20. The ammonium nitrate storage and dispensing apparatus of claim 8 wherein the screw is an Archimedes screw.

21. The ammonium nitrate storage and dispensing apparatus of claim 1 wherein there is a single dispensing unit.

22. The ammonium nitrate storage and dispensing apparatus of claim 21 wherein the dispensing unit includes at least one dispensing hopper for collecting ammonium nitrate from at least one of the at least two rotatable bowls and at least one dispensing conveyor to dispense ammonium nitrate from the dispensing hopper.

23. A method of storing and dispensing ammonium nitrate including the steps of:
storing ammonium nitrate in at least two rotatable bowls by rotating the rotatable bowls in a first direction; and
dispensing ammonium nitrate from the at least two rotatable bowls by rotating the rotatable bowls in a second direction.

24. The method of claim 23 further including the step of delivering ammonium nitrate from a vehicle to the rotatable bowls.

25. The method of claim 23 further including the step of dispensing ammonium nitrate from the at least two rotatable bowls to a vehicle.

26. The method of claims 23 further including the step of delivering ammonium nitrate to the at least two rotatable bowls via a delivery unit.

27. The method of claims 23 further including the step of dispensing ammonium nitrate from the at least two rotatable bowls via a dispensing unit.

28. The method of claims 23 further including the step of delivering ammonium nitrate to the at least two rotatable bowls via a delivery conveyor.

29. The method of claims 23 further including the step of delivering ammonium nitrate from the at least two rotatable bowls via a dispensing conveyor.
